(19) United States
(12) Patent Application Publication
(10) Pub. No.: US 2009/0220663 A1
(43) Pub. Date: Sep. 3, 2009

(54) Process and composition of preparing granular sucralose for emulating table sugar

(75) Inventors: Rajesh Kshirsagar, Gujarat (IN); Mayank Joshi, Gujarat (IN); Amresh Kumar, Gujarat (IN)

Correspondence Address: HAMRE, SCHUMANN, MUELLER & LARSON, P.C., P.O. BOX 2902, MINNEAPOLIS, MN, 55402-0902, US

(73) Assignee: ALEMBIC LIMITED, Vadodara (IN)

(21) Appl. No.: 10/558,514

(22) PCT Filed: Oct. 10, 2005
(86) PCT No.: PCT/IN05/00336

§ 371 Date: Nov. 28, 2005

(30) Foreign Application Priority Data
Jun. 22, 2005 (IN) 743/MUM/2005

(51) Int. Cl. A23L 1/236; A23L 1/0522; A23P 1/02

(52) U.S. Cl. 426/548; 426/578; 426/495

(57) ABSTRACT

A low-calorie solid, pourable composition for emulating sugar, the composition comprising an intense sweetener and at least one low-calorie bulking agent selected from maltodextrin, magnesium oxide, magnesium carbonate, calcium stearate, colloidal silicon dioxide and starch or combinations thereof, and a process for the preparation of said composition.

The present invention discloses sucralose-containing granules and a process for making such granules. The granules have good flow properties, low dust formation, good mechanical strength, no tendency to generate static electric charge, and good stability. Specifically, the objectives of this invention are: 1) to provide a more stable dry sucralose material which having low bulk density; and 2) to provide a process for obtaining such a highly desirable form of dry sucralose with the ability to imitate table top sugar.

High-intensity sweeteners can provide the sweetness of sugar, with various taste qualities. Because they are many times sweeter than sugar, however, much less of the sweetener is required to replace the sugar. High-intensity sweeteners have a wide range of chemically distinct structures and hence possess varying properties. Sucralose (1,6-dichloro-1,6-dideoxy-p-D-fructofuranosyl-4-chloro-4-deoxy-a-D-galactopyranoside) is a high-intensity sweetener made by the selective chlorination of sucrose. Sucralose is a white, crystalline, nonhygroscopic, free-flowing powder in its pure form. It is highly soluble in water, ethanol, and methanol and has a negligible effect on the pH of solutions.

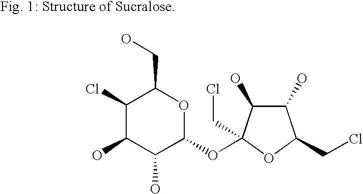

This invention relates to low-calorie sugar emulants, and to methods for making the same. Low-calorie sugar emulants are extensively used in the food production and catering industries, introduced into foodstuffs to provide a sweet taste without making the food energy-rich. Such low calorie sugar emulants are made widespread use of in the ‘diet’ or ‘light’ foods aimed at slimmers and others on calorie-controlled diets. Sugar emulants are also used in food products made for diabetics. By low-calorie sugar emulant it is meant a composition having sweetness similar to that of sucrose, but which yields only a fraction of the energy to a body. Sucrose delivers up to 16.5 Jg<−1> (3.94 cal/g<−1>) in a healthy human adult.

European Patent No. 0411991 to Searle de France SA also discloses an aspartame based sugar emulant. The sugar emulant is made by freeze-drying (lyophilizing) a solution of up to 2% aspartame, up to 5% dextrose or hydrogenated dextrose and up to 40% hydrogenate isomaltose in water. The solution is freeze-dried in moulds, to give a product like a lump of sugar, designed for use in sweetening beverages as the loose powder form is not sufficiently resistant to handling.

European Patent No. 1060674A2 discloses a low calorie solid, pourable composition for emulating sugar. The sugar emulant is made by melt spun process. The composition comprising an intense sweetener and at least one low calorie bulking agent. Process involves feedstock a mixture comprising an intense sweetener and at least one low calorie bulking agent, introducing the mixed feedback into a spinning machine having a spinning head with a flash flow array and a central axis of rotation, and melt spinning the feedstock. Depending upon the parameters of the melt-spinning, especially temperature, aperture sizes in the walls of the spinning head and rotational speed, the product may comprise filaments, flakes or particles or agglomeration of particles. The product is required to be subjected to further modifications, e.g. grinding or agglomeration to produce the desired particle size.

According to one aspect of the invention there is provided a low-calorie solid, pourable composition for emulating sugar, the composition comprising an intense sweetener and at least one low-calorie bulking agent. The other important aspect of the invention is a conventional process of preparing the pourable granule of sucralose using simple equipment and capital conservative process. The said artificial sweetener composition contains sucralose and a low bulk density bulking agent or combination thereof such as, maltodextrin, magnesium oxide, magnesium carbonate, calcium stearate, colloidal silicon dioxide and starch.

In a preferred embodiment of the present invention, low density sucralose granules prepared by granulating at least one or combination of low density bulking agent using simple and conventional granulator. Granulation fluid comprising of sucralose dissolved or suspended in a suitable solvent, said solvent can be selected from P. Water, Polyethylene glycol, Propylene glycol, Methanol, Ethanol, Acetone, isopropyl alcohol, Dichloromethane or combination of solvents. The artificial sweetener used in the present invention is sucralose, which preferably comprises 0.1 to 50% of the final granular product. Granulate the low bulk density bulking agents with the above granulating fluid using granulator such as planetary mixer, rapid mixer granulator, mass mixer, fluid bed granulator or ribbon mixer, etc. The said low density bulking agent can be an inert material suitable for oral ingestion having a bulk density below 0.3 g/cc. The example of such low bulk density agents include maltodextrin, magnesium oxide, magnesium carbonate, calcium stearate, colloidal silicon dioxide, starch, microcrystalline cellulose, powered cellulose, etc., and it preferably comprises 50 to 99.99% of the final product weight. These low density bulking agents can be advantageously used as alone or in combination.

After granulation of above bulking agents with granulating fluid, dry the wet mass for the removal of solvent by using the proper dryer such as tray dryer, fluid bed dryer, etc to achieve the moisture content of granules below 10.0% w/w. Size the dried granules through a # 16 sieve to obtain the desired granules size fractions.

The formed granules can be directly used as a table top emulant or may be further diluted with the bulking agent. If it is further diluted with the bulking agent the diluting portion can constitute from about 10 to 95% w/w of the final product weight. The process of dilution can involve geometric dilution for achieving uniformity of mixing and can be performed using any equipment capable of dry mixing.

The above process is a conventional and simple process of preparing the pourable granule of sucralose using simple equipment and capital conservative process. The present invention can be illustrated by the following examples without being limited by them.

### EXAMPLE 1-8

### Preparation of Aqueous Granulated Sweetener

A granulating fluid is prepared by dissolving sucralose in purified water under stirring till it makes clear solution.

Weigh the different low density bulking agents such as maltodextrin (Ex. 1), magnesium oxide (Ex. 2), microcrystalline cellulose (Ex. 3), magnesium carbonate (Ex. 4), calcium stearate (Ex. 5), colloidal silicon dioxide (Ex. 6), starch (Ex. 7) or dibasic calcium phosphate (Ex. 8) as illustrated in Table 1. Granulate these bulking agents with the above aqueous granulating fluid in an s.s. vessel with mixing using an s.s. blade. Dry the wet granules at 60° C. for 90 minutes or till the moisture content of dried granules are less than 6.0% w/w. Size the dried granules through a # 16 sieve to obtain the desired granules size fraction.

These fractions were evaluated for moisture content, bulk density, particle size distribution and flowability. Moisture content was measured using halogen moisture analyzer, bulk density was measured using a cylinder of known volume. Table 6 summarizes the testing results for densities, moisture content.

TABLE 1
Composition of Sucralose granules (Example 1 to 8).

| | Quantity (mg/gram) | | | | | | | |
|---|---|---|---|---|---|---|---|---|
| Ingredients | Ex 1 | Ex 2 | Ex 3 | Ex 4 | Ex 5 | Ex 6 | Ex 7 | Ex 8 |
| Sucralose | 12 | 12 | 12 | 12 | 12 | 12 | 12 | 12 |
| Maltodextrin | 988 | — | — | — | — | — | — | — |
| Magnesium oxide | — | 988 | — | — | — | — | — | — |
| Microcrystalline | — | — | 988 | — | — | — | — | — |
| cellulose | | | | | | | | |
| Magnesium carbonate | — | — | — | 988 | — | — | — | — |
| Calcium Stearate | — | — | — | — | 988 | — | — | — |
| Colloidal Silicon dioxide | — | — | — | — | — | 988 | — | — |
| Starch | — | — | — | — | — | — | 988 | — |
| Dibasic calcium phosphate | — | — | — | — | — | — | — | 988 |
| Purified Water | qs | Qs | qs | qs | qs | qs | qs | qs |

### EXAMPLE 9-16

### Preparation of Non-Aqueous Granulated Sweetener

A granulating fluid is prepared by dissolving sucralose in Denatured Ethanol (with 0.5% w/w acetone as a denaturant) under stirring till it makes clear solution.

Weigh the different low density bulking agents such as maltodextrin (Ex. 9), magnesium oxide (Ex. 10), microcrystalline cellulose (Ex. 11), magnesium carbonate (Ex. 12), calcium stearate (Ex. 13), colloidal silicon dioxide (Ex. 14), starch (Ex. 15) or dibasic calcium phosphate (Ex. 16) as illustrated in (Table 2). Granulate these bulking agents with the above non aqueous granulating fluid in an s.s. vessel with mixing using an s.s. blade. Dry the wet granules at 45° C. for 60 minutes or till the moisture content of dried granules are less than 6.0% w/w. Size the dried granules through a # 16 sieve to obtain the desired granules size fraction.

These fractions were evaluated for moisture content, bulk density, particle size distribution and flowability. Moisture content was measured using halogen moisture analyzer, bulk density was measured using a cylinder of known volume. Table 6 summarizes the testing results for densities, moisture content.

TABLE 2
Composition of Sucralose granules (Example 9 to 16).

| | Quantity (mg/gram) | | | | | | | |
|---|---|---|---|---|---|---|---|---|
| Ingredients | Ex 9 | Ex 10 | Ex 11 | Ex 12 | Ex 13 | Ex 14 | Ex 15 | Ex 16 |
| Sucralose | 12 | 12 | 12 | 12 | 12 | 12 | 12 | 12 |
| Maltodextrin | 988 | — | — | — | — | — | — | — |
| Magnesium oxide | — | 988 | — | — | — | — | — | — |
| Microcrystalline cellulose | — | — | 988 | — | — | — | — | — |
| Magnesium carbonate | — | — | — | 988 | — | — | — | — |
| Calcium Stearate | — | — | — | — | 988 | — | — | — |
| Colloidal Silicon dioxide | — | — | — | — | — | 988 | — | — |
| Starch | — | — | — | — | — | — | 988 | — |
| Dibasic calcium phosphate | — | — | — | — | — | — | — | 988 |
| Denatured Ethanol | qs | qs | qs | qs | qs | qs | qs | qs |

### EXAMPLE 17-18

### Preparation of Sucralose Granules

A granulated fluid is prepared by dissolving sucralose in denatured ethanol under stirring till it makes clear solution. Weigh the low density bulking agent magnesium oxide (Table 3). Granulate it with above non aqueous granulating fluid in an s.s. vessel with mixing using an s.s. blade. Dry the wet granules at 45° C. for 60 minutes or till the 20 moisture content of dried granules are less than 6.0% w/w. Size the dried granules through a # 16 sieve to obtain the desired granules size fraction.

TABLE 3
Composition of Sucralose granules (Example 17-18).

Quantity
(mg/gram)

| Ingredients | Ex 17 | Ex 18 |
|---|---|---|
| Binder fluid | | |
| Sucralose | 1 | 500 |
| Denatured alcohol | qs | qs |
| Core material | | |
| Magnesium oxide | 999 | 500 |

### EXAMPLE 19-20

### Preparation of Sucralose Granules Using Combination of Bulking Agent

A granulated fluid is prepared by dissolving sucralose in denatured ethanol under stirring till it makes clear solution. Weigh the low density bulking agents and mix well using proper mixer (Table 4). Granulate it with above non aqueous granulating fluid in an s.s. vessel with mixing using an s.s. blade. Dry the wet granules at 45° C. for 60 minutes or till the moisture content of dried granules are less than 6.0% w/w. Size the dried granules through a # 16 sieve to obtain the desired granules size fraction.

TABLE 4
Composition of Sucralose granules (Example 19-20).

Quantity
(mg/gram)

| Ingredients | Ex 19 | Ex 20 |
|---|---|---|
| Binder fluid | | |
| Sucralose | 12 | 12 |
| Denatured alcohol | qs | qs |
| Core material | | |
| Magnesium oxide | 593 | 593 |
| Magnesium carbonate | 395 | 345 |
| Colloidal silicon dioxide | — | 50 |

### EXAMPLE 21

### Preparation of Sucralose Granules Using Hydro Alcoholic Solvents

A granulated fluid is prepared by dissolving sucralose in the mixture of isopropyl alcohol and purified water (ratio is 90:10 respectively) under stirring till it makes clear solution. Weigh the low density bulking agent magnesium oxide (Table 5). Granulate it with above non aqueous granulating fluid in an s.s. vessel with mixing using an s.s. blade. Dry the wet granules at 45° C. for 60 minutes or till the moisture content of dried granules are less than 6.0% w/w. Size the dried granules through a # 16 sieve to obtain the desired granules size fraction.

TABLE 5
Composition of Sucralose granules (Example 21).

| | Quantity |
|---|---|
| Ingredients | (mg/gram) |
| Binder fluid | |
| Sucralose | 12 |
| Isopropyl alcohol | qs |
| Purified water | qs |
| Core material | |
| Magnesium oxide | 988 |

### EXAMPLE 22

### Preparation of Sucralose Granules Using Sucrose and Maltodextrin as Bulking Agent

A granulated fluid is prepared by dissolving sucralose in denatured ethanol under stirring till it makes clear solution. Weigh the low density bulking agents, sucrose and Maltodextrin and mix well using proper mixer (Table 6). Granulate it with above non aqueous granulating fluid in an s.s. vessel with mixing using an s.s. blade. Dry the wet granules at 45° C. for 60 minutes or till the moisture content of dried granules are less than 6.0% w/w. Size the dried granules through a # 16 sieve to obtain the desired granules size fraction.

TABLE 6
Composition of Sucralose granules (Example 22).

| | Quantity |
|---|---|
| Ingredients | (mg/gram) |
| Binder fluid | |
| Sucralose | 12 |
| Denatured ethanol | qs |
| Core material | |
| Sucrose | 494 |
| Maltodextrin | 494 |

### EXAMPLE 23

The bulk density and the Loss on drying of the core and granules for example 1-22 were evaluated and are recorded in Table 7. Flow property of the granules was observed in terms of homogenous and consistent falling of granules from spoon by visually observation. The observed flow property is recorded in Table 7.

TABLE 7
Physical Properties of Granulated Sucralose

| | Bulk density (g/cc) | | | LOD (% w/w) at 105□C. | | | |
|---|---|---|---|---|---|---|---|
| | | Granules | | | Granules | | |
| | | with | | | with | Granules | |
| | Core | ethanol/ | Granules | Core | ethanol/ | with | Flow |
| Bulking agent | material | IPA | with water | material | IPA | water | Property |
| Example 1 | 0.13 | — | 0.34 | 6.85 | — | 6.35 | Excellent |
| Example 2 | 0.14 | — | 0.31 | 0.6 | — | 2.16 | Good |
| Example 3 | 0.20 | — | 0.21 | 3.20 | — | 2.39 | Excellent |
| Example 4 | 0.12 | — | 0.23 | 2.91 | — | 1.18 | Good |
| Example 5 | 0.16 | — | 0.13 | 0.1 | — | 0.46 | Poor |
| Example 6 | 0.04 | — | 0.1 | 1.58 | — | 3.87 | Poor |
| Example 7 | 0.19 | — | 0.25 | 5.5 | — | 2.30 | Good |
| Example 8 | 0.23 | — | 0.24 | 0.6 | — | 2.1 | Poor |
| Example 9 | 0.13 | 0.19 | — | 6.85 | 6.73 | — | Excellent |
| Example 10 | 0.14 | 0.21 | — | 0.6 | 0.49 | — | Good |
| Example 11 | 0.20 | 0.22 | — | 3.20 | 2.26 | — | Good |
| Example 12 | 0.12 | 0.16 | — | 2.91 | 1.69 | — | Good |
| Example 13 | 0.16 | 0.26 | — | 0.1 | 0.39 | — | Poor |
| Example 14 | 0.04 | 0.07 | — | 1.58 | 1.09 | — | Poor |
| Example 15 | 0.19 | 0.22 | — | 5.5 | 1.85 | — | Good |
| Example 16 | 0.23 | 0.34 | — | 0.6 | 0.82 | — | Poor |
| Example 17 | 0.14 | 0.23 | — | 0.6 | 0.56 | — | Good |
| Example 18 | 0.14 | 0.26 | — | 0.6 | 0.89 | — | Poor |
| Example 19 | 0.14 | 0.21 | — | 1.75 | 1.15 | — | Poor |
| Example 20 | 0.14 | 0.23 | — | 1.75 | 1.36 | — | Poor |
| Example 21 | 0.14 | 0.21 | — | 0.6 | 1.05 | — | Good |
| Example 22 | 0.51 | 0.49 | — | 1.82 | 2.54 | — | Good |

The flow property of the granules was found superior in following sequence. Maltodextrin>Microcrystalline cellulose>Magnesium oxide>Magnesium carbonate>Dibasic calcium phosphate>Calcium Stearate>Colloidal Silicon dioxide.

A good flow of granulated sucralose is helpful for efficient mixing and blend uniformity and is a most important requirement for emulating tablet top sugar.

The sucralose granules obtained by the said process have a mean particle size between 100 and 2000 micron.

1. A free flowing, low density, granular sucralose composition with the ability to imitate table top sugar and constituting of sucralose and at least one or combination of low density bulking agent.

2. A composition according to claim 1 wherein granules comprises from 0.01% w/w to about 15% w/w of sucralose and about 85% w/w to about 99.99% w/w of low bulk density bulking agent(s).

3. A composition according to claim 1 wherein the bulk density of low calorie sugar emulant upon preparation is in the range from 0.05 to 0.7 g/cc. preferably it is in the range of 0.1 to 0.5 g/cc and more preferably it is in the range of 0.1 to 0.3 g/cc.

4. A composition according to claim 1 where in the low density bulking agent(s) is selected from maltodextrin, magnesium oxide, magnesium carbonate, calcium stearate, colloidal silicon dioxide, starch, microcrystalline cellulose, powered cellulose or dicalcium phosphate.

5. A composition according to claim 1 wherein the bulk density of low density bulking agent(s) is in the range from 0.05 to 0.2 g/cc.

6. A composition according to claim 1 where in the bulking agent is sucrose in combination with the low density bulking agent selected from maltodextrin, magnesium oxide, magnesium carbonate, calcium stearate, colloidal silicon dioxide, starch, microcrystalline cellulose, powered cellulose or dicalcium phosphate.

7. A composition according to claim 1 wherein low bulk density bulking agent is a combination of two bulking agents and are present in a ratio in the range of 1: 9 to 9:1.

8. A method for preparation of free flowing, low density, granular sucralose composition with the ability to imitate table top sugar and constituting of sucralose and at least one or combination of low density bulking agent, comprising:
I. Dissolving sucralose in a suitable solvent system to prepare a clear solution.
II. Adsorbing the solution of sucralose on to a suitable bulking agent by pouring on it the solution with gentle mixing.
III. The formed wet mass is dried and sized through appropriate sieve to obtain the desired granules size fractions.
IV. The granules formed can optionally be mixed with low density bulking agents.

9. The process of preparation according to claim 8 wherein the solvent system used for dissolving sucralose can be aqueous, non-aqueous or hydro-alcoholic.

10. A method for preparation of free flowing, low density, granular sucralose composition with the ability to imitate table top sugar and constituting of sucralose and low density maltodextrin, comprising:
I. Dissolving sucralose in a suitable solvent system to prepare a clear solution.
II. Adsorbing the solution of sucralose on to a low density maltodextrin by pouring on it the solution with gentle mixing.
III. The formed wet mass is dried and sized through appropriate sieve to obtain the desired granules size fractions.
IV. The granules formed can optionally be mixed with low density maltodextrin.
